(19) United States
(12) Patent Application Publication
(10) Pub. No.: US 2026/0185383 A1
(43) Pub. Date: Jul. 2, 2026

(54) Smart Lock And Thumb-Turn Resetting Mechanism Thereof

(71) Applicant: PIN GENIE Limited., Kowloon (HK)

(72) Inventor: Zheng Li, Kowloon (HK)

(73) Assignee: PIN GENIE Limited, Kowloon (HK)

(21) Appl. No.: 19/007,767

(22) Filed: Jan. 2, 2025

(51) Int. Cl. E05B 15/00; E05B 47/00

(52) U.S. Cl. CPC E05B 15/0086; E05B 2047/0094

(57) ABSTRACT

Provided in the present disclosure are a smart lock and a thumb-turn resetting mechanism. The thumb-turn resetting mechanism comprises a cover plate; an actuation structure configured to be movable relative to the cover plate; a lock cylinder comprising a cylinder core and a cylinder tail rod being rotatable relative to each other, wherein the cylinder core is configured to be connected to and in synchronous rotation with the actuation structure; and a tail-rod resetting structure configured to drive the cylinder tail rod to rotate, and wherein a connecting member is arranged between the actuation structure and the tail-rod resetting structure for establishing connection therebetween.

### FIELD

The present disclosure relates to the technical field of smart locks, and in particular to a smart lock and a thumb-turn resetting mechanism thereof.

### BACKGROUND

For most of the existing door locks, it is required to rotate thumb turn means thereof by 90 degrees clockwise or counterclockwise for unlocking, and to reversely rotate thumb turn means by 90 degrees to back to its original position for locking. However, thumb turn means currently available on the market may stay in a rotated position after unlocking and/or locking is performed but could not return to its initial position. Thus, it is difficult for users to grasp whether the thumb turns are rotated by sufficient angles in order to unlock and/or lock the door lock, making it inconvenient to use.

### SUMMARY

An objective of the present disclosure is to provide a smart lock and a thumb-turn resetting mechanism thereof, which make it possible to actuate a thumb turn back to its original position, so as to provide use convenience to a user.

To achieve the objective above, the present disclosure provides the following technical solution.

In an aspect of the present disclosure, a thumb-turn resetting mechanism is provided comprising: a cover plate; an actuation structure configured to be movable relative to the cover plate; a lock cylinder comprising a cylinder core and a cylinder tail rod being rotatable relative to each other, wherein the cylinder core is configured to be connected to and in synchronous rotation with the actuation structure; and a tail-rod resetting structure configured to drive the cylinder tail rod to rotate, and wherein a connecting member is arranged between the actuation structure and the tail-rod resetting structure for establishing connection therebetween.

Wherein, a first resetting member is arranged between the cover plate and the actuation structure, a second resetting member is arranged between the tail-rod resetting structure and the cover plate, such that in the case where the connection established between the actuation structure and the tail-rod resetting structure via the connecting member is disconnected, the actuation structure and the tail-rod resetting structure are actuated to return to their original positions due to restoring force of the first resetting member and the second resetting member, respectively.

Additionally or alternatively, each of the first resetting member and the second resetting member comprises a torsion spring.

Additionally or alternatively, the actuation structure comprises a thumb turn, a thumb turn base, and a thumb turn joint all being arranged in synchronous rotation, and the thumb turn joint is provided with a bump configured to abut against the first resetting member.

Additionally or alternatively, the thumb turn joint is provided with a sliding groove, the tail-rod resetting structure is provided with a slot at a position corresponding to the sliding groove, and the connecting member comprises a clutch pin that is slidably arranged in the sliding groove.

Additionally or alternatively, a rebound member is disposed within the sliding groove and is configured to be connected to the clutch pin to allow the clutch pin being moved out of the slot and returning to its original position.

Additionally or alternatively, the cover plate is provided with an electronic clutch that is configured to receive an external control instruction to push the clutch pin to be inserted into the slot.

Additionally or alternatively, the tail-rod resetting structure includes a resetting rotation disc having a rotation hole, through which the cylinder tail rod extends, being provided at the center of the resetting rotation disc.

Additionally or alternatively, the rotation hole is shaped as a profiled hole that is formed by two sector holes being connected at their corner ends and arranged centro-symmetrically, and wherein the rotation hole has a first side surface, a second side surface, a third side surface, and a fourth side surface, and whereby the first side surface and the second side surface are provided adjacent to each other and the third side surface and the fourth side surface are provided adjacent to each other.

Additionally or alternatively, the cylinder tail rod is configured to be rotatable relative to the resetting rotation disc in the rotation hole with a rotatable range of being greater than 90 degrees.

Additionally or alternatively, the resetting rotation disc is provided with a protrusion that is configured to abut against an end of the second resetting member.

Additionally or alternatively, the thumb turn joint is provided with a left threaded hole and a right threaded hole, and the resetting rotation disc is provided with a blocking piece, and wherein an orientating screw is provided in the left threaded hole or the right threaded hole and in threaded connection thereto, and the orientating screw is configured to abut against the blocking piece, so as to restrict a direction in which a relative rotation between the tail-rod resetting structure and the actuation structure occurs.

Additionally or alternatively, the thumb-turn resetting mechanism further comprises a key, and wherein the cylinder core is provided with a lock hole that is configured to accept the key being inserted therein to allow synchronous rotation of the cylinder core and the cylinder tail rod.

Additionally or alternatively, the actuation structure is configured to be pivotable or rotatable relative to the cover plate.

In a second aspect of the present disclosure, a thumb-turn resetting structure is provided, comprising: a cover plate; a thumb turn assembly; and a transmission assembly, wherein the thumb turn assembly and the transmission assembly are both configured to be movable relative to the cover plate, the thumb turn assembly is connected to the transmission assembly such that the transmission assembly is controllable to control extending and retracting movements of a bolt, and wherein the thumb turn assembly is further provided with a resetting assembly that is configured to actuate the thumb turn assembly to return to its original position after having been rotated.

Additionally or alternatively, the thumb turn assembly and the transmission assembly are both configured to be pivotable or rotatable relative to the cover plate.

Additionally or alternatively, the thumb turn assembly is configured to actuate the transmission assembly to be rotated by a rotation angle of 90 degrees in controlling the extending and retracting movements of the bolt.

Additionally or alternatively, the thumb turn assembly comprises an actuation structure and a tail-rod resetting structure, and wherein the resetting assembly comprises a third resetting member, and the actuation structure and the tail-rod resetting structure are provided with a first pushing block and a second pushing block, respectively, which are configured to be connected to the third resetting member.

In a third aspect of the present disclosure, a smart lock is provided, comprising: a lock case; a thumb-turn resetting mechanism; and a lock body. Wherein the thumb-turn resetting mechanism comprises: a cover plate; an actuation structure configured to be movable relative to the cover plate; a lock cylinder comprising a cylinder core and a cylinder tail rod being rotatable relative to each other, wherein the cylinder core is configured to be connected to and in synchronous rotation with the actuation structure; and a tail-rod resetting structure configured to drive the cylinder tail rod to rotate, and wherein a connecting member is arranged between the actuation structure and the tail-rod resetting structure for establishing connection therebetween. Wherein, a first resetting member is arranged between the cover plate and the actuation structure, a second resetting member is arranged between the tail-rod resetting structure and the cover plate, such that in the case where the connection established between the actuation structure and the tail-rod resetting structure via the connecting member is disconnected, the actuation structure and the tail-rod resetting structure are actuated to return to their original positions due to restoring force of the first resetting member and the second resetting member, respectively. Wherein, the thumb-turn resetting mechanism is mounted in the lock case such that the thumb-turn resetting mechanism is configured to be connected to the lock body and to control extending and retracting movements of the lock body.

Compared with the prior art, the inventive concept of the present disclosure has the following advantages:
1. In the thumb-turn resetting mechanism according to the present disclosure, it is possible to allow individually resetting an actuation structure and a tail-rod resetting structure using a first resetting member and a second resetting member. It facilitates user operation for the actuation structure to control the unlocking and locking of the door lock.
2. The thumb-turn resetting mechanism of the present disclosure makes it possible to return a thumb turn back to its initial position by additionally providing a torsion spring in conjunction with a clutch connection. This may simplify a resetting structure compared to that of an existing thumb turn, and improve the durability and reliability of a smart lock.
3. In the smart lock according to the present disclosure, with the thumb-turn resetting mechanism applied to the smart lock, it is possible to ensure that the thumb turn may return to its initial position upon being finished using each time. Also, it is not required for a user to manually reset the thumb turn, thereby improving the use experience of the user.

Additional aspects and advantages of the present disclosure will be set forth in part in the following description, which will become apparent from the following description, or may be learned by practice of the present disclosure.

### BRIEF DESCRIPTION OF THE DRAWINGS

The above and/or additional aspects and advantages of the present disclosure will become apparent and easily comprehensible from the following description of embodiments in below in conjunction with drawings.

FIG. 1 is a schematic view for the front structure of an embodiment of a thumb-turn resetting mechanism in the present disclosure;

FIG. 2 is a schematic view for the back structure of an embodiment of the thumb-turn resetting mechanism in the present disclosure;

FIG. 3 is a schematic view for the internal structure of the of an embodiment of the thumb-turn resetting mechanism in the present disclosure;

FIG. 4 is a exploded view for the structure of an embodiment of the thumb-turn resetting mechanism in the present disclosure;

FIG. 5 is another exploded view for the structure of an embodiment of the thumb-turn resetting mechanism in the present disclosure from another perspective;

FIG. 6 is a schematic view of an actuation structure in an embodiment of the thumb-turn resetting mechanism in the present disclosure;

FIG. 7 is a schematic view of a thumb turn joint in an embodiment of the thumb-turn resetting mechanism in the present disclosure;

FIG. 8 is a schematic view of a resetting rotation disc in an embodiment of the thumb-turn resetting mechanism in the present disclosure;

FIG. 9 is a schematic view of an actuation structure in an embodiment of the thumb-turn resetting mechanism in the present disclosure;

FIG. 10 is a schematic view for the structure of an embodiment of a smart lock in the present disclosure;

FIG. 11a is a schematic view of a resetting rotation disc and a cylinder tail rod at thei initial positions in a locked state in an embodiment of the smart lock in the present disclosure;

FIG. 11b is a schematic view in which a cylinder tail rod is pushed to an unlocked position by a resetting rotation disc in an embodiment of the smart lock in the present disclosure;

FIG. 11c is a schematic view in which the resetting rotation disc is returned back to its initial position in the unlocked state in an embodiment of the smart lock in the present disclosure; and

FIG. 11d is a schematic view in which a cylinder tail rod is pushed to a locked position by a resetting rotation disc in an embodiment of the smart lock in the present disclosure.

In the drawings,

| | |
|---|---|
| 1: cover plate; | 11: stopper block; |
| 2: actuation structure; | 21: thumb turn; |
| 22: thumb turn base; | 23: thumb turn joint; |
| 231: sliding groove; | 232: bump; |
| 233: left threaded hole; | 234: right threaded hole; |
| 235: first pushing block; | 3: lock cylinder; |
| 31: cylinder core; | 32: cylinder tail rod; |
| 33: lock hole; | 4: tail-rod resetting structure; |
| 41: resetting rotation disc; | 411: protrusion; |
| 412: second pushing block; | 42: blocking piece; |
| 43: rotation hole; | 43a: first side surface; |
| 43b: second side surface; | 43c: third side surface; |
| 43d: fourth side surface; | 44: slot; |
| 5: first resetting member; | 6: second resetting member; |
| 71: electronic clutch; | 72: clutch pin; |
| 73: rebound member; | 8: third resetting member; |
| 9: orientating screw; | 1000: lock case; |
| 2000: lock body; | 2001: bolt; and |

3000: thumb-turn resetting mechanism.

### DETAILED DESCRIPTION

Embodiments of the present disclosure will be described in detail below, and examples of the embodiments are shown in the drawings, with the same or similar reference signs throughout the drawings representing the same or similar elements or the elements having the same or similar functions. The embodiments described below with reference to the drawings are exemplary and are merely used to be illustrative of the present disclosure, but should not be construed as limiting the present disclosure.

It should be understood that various steps recited in method implementations of the present invention may be executed in different orders, and/or concurrently executed. In addition, the method implementations may include additional steps and/or omit the execution of shown steps. The scope of the present invention is not limited in this respect.

The term “include” and the variations thereof as used herein refer to open-ended inclusion, i.e., “including, but not limited to”. The term “connect” may be a direct connection, and may also be an indirect connection via an intermediate component (element). The term “an embodiment” denotes “at least one embodiment”. The term “another embodiment” denotes “at least one further embodiment”. The term “some embodiment” denotes “at least some embodiments”. Related definitions of the other terms will be given in the description below.

It should be noted that the concepts “first”, “second”, etc. recited in the present invention are merely used for distinguishing apparatuses, modules or units, are not used for definitely defining these apparatuses, modules or units as different apparatuses, modules or units, and are also not used for defining orders of functions implemented by these apparatuses, modules or units, or mutual dependencies thereof.

Facing the problem where a thumb turn of traditional smart door locks could not return to its initial position after a door is unlocked/locked, the present inventive concept provides a thumb-turn resetting mechanism, which may comprise a cover plate, a thumb turn assembly, and a transmission assembly. The thumb turn assembly and the transmission assembly may be both movable relative to the cover plate. Preferably, the thumb turn assembly and the transmission assembly may be both configured to be pivotable or rotatable relative to the cover plate. In the embodiment, he thumb turn assembly and the transmission assembly may be both rotatable relative to the cover plate. The thumb turn assembly may be connected to the transmission assembly such that the transmission assembly may be controlled to control the extending and retracting movements of a bolt. The thumb turn assembly may be further provided with a resetting assembly that is configured to actuate the thumb turn assembly to return to its original position after having been rotated. As such, with the thumb-turn resetting structure of the present disclosure, it is possible to, after the thumb turn assembly is actuated to rotate the transmission assembly, return the thumb turn assembly back to its original position through the resetting assembly. It is not required for a user to manually reset the thumb turn assembly, thereby improving the use convenience of the user.

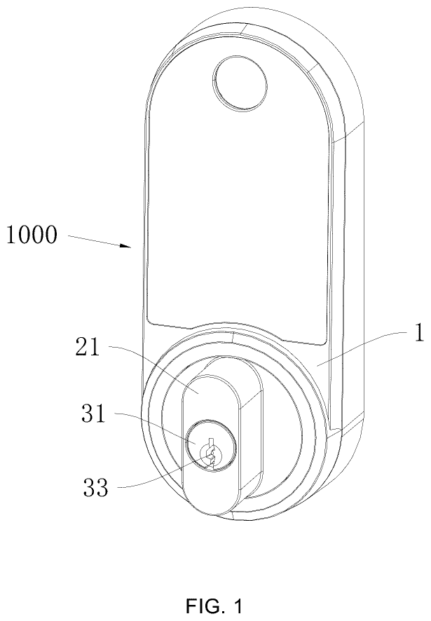

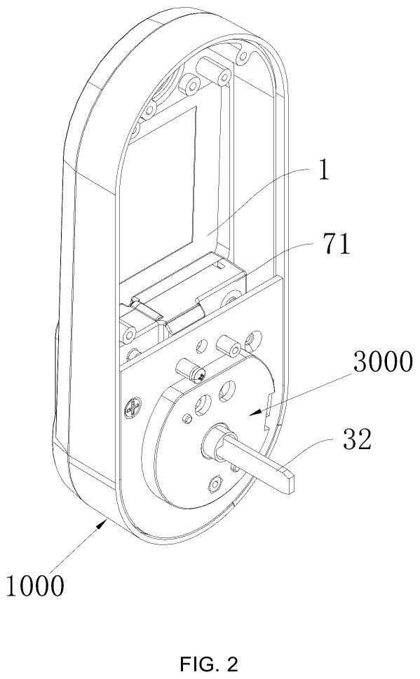

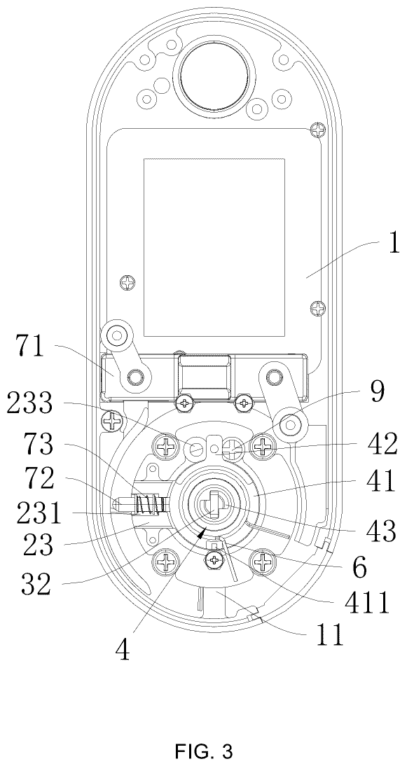

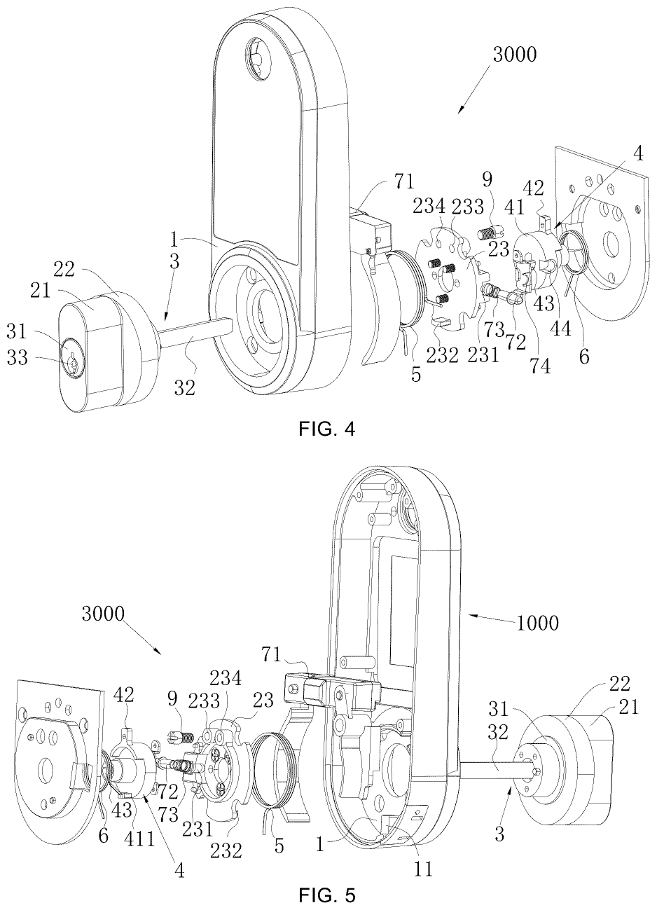

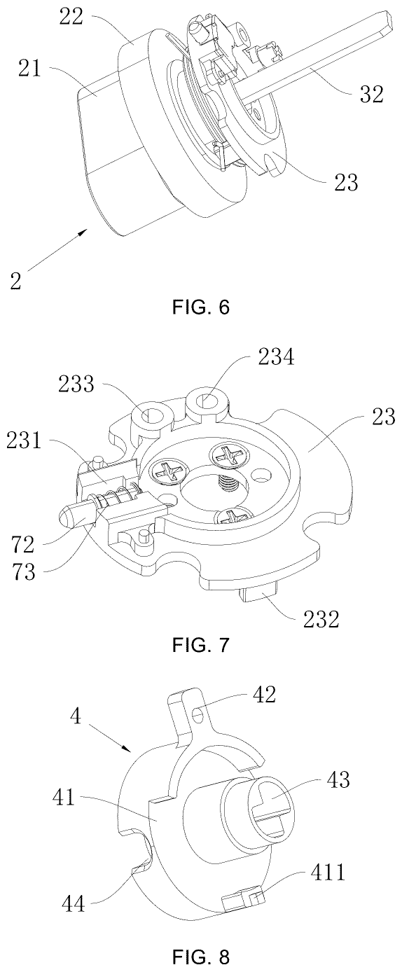

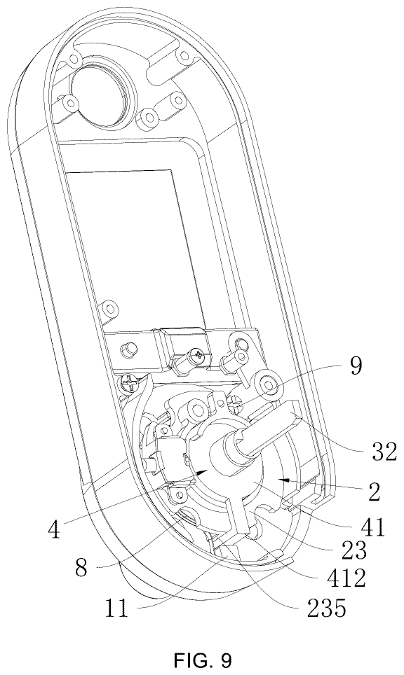

In a specific embodiment, referring to FIGS. 1 to 5, a thumb-turn resetting mechanism of the present disclosure may include a cover plate 1, a thumb turn assembly and a transmission assembly. The cover plate 1 is configured to be secured to a door plate on which a smart lock is mounted. The thumb turn assembly may include an actuation structure 2 and a tail-rod resetting structure 4. The transmission assembly may include a lock cylinder 3. The actuation structure 2 may be mounted on the cover plate 1 and configured to be movable relative to the cover plate 1. Preferably, the actuation structure 2 is configured to be pivotable and/or rotatable relative to the cover plate 1. In the embodiment, the actuation structure 2 is configured to be rotatable relative to the cover plate 1. The lock cylinder 3 may include a cylinder core 31 and a cylinder tail rod 32 rotatable relative to each other. The cylinder core 31 is connected with the actuation structure 2 for synchronous rotation. The cylinder tail rod 32 is configured to be connected to a bolt 2001 for controlling the unlocking and/or locking of the door lock. The tail-rod resetting structure 4 may be sleeved over the cylinder tail rod 32, and the tail-rod resetting structure 4 and the cylinder tail rod 32 are configured to drive the rotation of the cylinder tail rod 32. Further, a connecting member is provided between the actuation structure 2 and the tail-rod resetting structure 4 for interconnecting them such that the cylinder core 31 and the cylinder tail rod 32 may be rotated synchronously. When the connection between the actuation structure 2 and the tail-rod resetting structure 4 is disconnected by the connecting member, the tail-rod resetting structure 4 may be rotatable relative to the actuation structure 2.

In the present disclosure, a first resetting member 5 may be arranged between the cover plate 1 and the actuation structure 2. When the actuation structure 2 is rotated relative to the cover plate 1, the first resetting member 5 may be elastically deformed and forced to provide a restoring force for the actuation structure 2 to return to its initial position. A second resetting member 6 may be arranged between the tail-rod resetting structure 4 and the cover plate 1. After the tail-rod resetting structure 4 has been rotated along with the cylinder tail rod 32, the second resetting member 6 may be elastically deformed and forced to provide a restoring force for the tail-rod resetting structure 4 to return to its initial position. The first resetting member 5 and the second resetting member 6 are provided as such resetting assemblies for the thumb turn assembly that, after the connection constraint by the connecting member for the actuation structure 2 and the tail-rod resetting structure 4 of the thumb turn assembly is released, the actuation structure 2 and the tail-rod resetting structure 4 may be returned to original positions by the first resetting member 5 and the second resetting member 6, respectively. It is not required for a user to manually reset the actuation structure 2, so as to provide convenient to the user for subsequent operation of the actuation structure 2, thereby improving the use experience of the user.

In a specific embodiment, the actuation structure 2 of the present disclosure may include a thumb turn 21, a thumb turn base 22, and a thumb turn joint 23, all of them being secured and connected by means of screws. The cylinder core 31 of the lock cylinder 3 may be mounted between the thumb turn 21 and the thumb turn base 22, such that the cylinder core 31 may be in synchronous rotation with the actuation structure 2. The cylinder tail rod 32 may extend into and through the thumb turn joint 23, such that the cylinder tail rod 32 may be rotatable relative to the actuation structure. Therefore, in the present disclosure, it is possible to rotate the actuation structure 2, and more particularly, to rotate the tail-rod resetting structure 4 along with the actuation structure 2 by means of the connection of the connecting member, so as to drive the rotation of the cylinder tail rod 32 in order to control the extending and retracting movements of the bolt, and thus enabling the unlocking and/or locking of the door lock.

It should be noted that, the present disclosure does not limit the specific structural form of the thumb turn 21, which may be implemented, for example, as a rotation disc and a handle, or the like.

The tail-rod resetting structure 4 of the present disclosure may include a resetting rotation disc 41. A rotation hole 43, through which the cylinder tail rod 32 may extend, is provided at the center of the resetting rotation disc 41. The cylinder tail rod 32 may be engaged with the rotation hole 43, such that when the resetting rotation disc 41 is driven by the actuation structure 2 and rotated, the cylinder tail rod 32 may be driven and in synchronous rotation drive.

The connecting member may provide detachable connection for the tail-rod resetting structure 4 with the actuation structure 2. In the embodiment, the connecting member may include a clutch pin 72. The thumb turn joint 23 is provided with a sliding groove 231, and the clutch pin 72 is slidably arranged in the sliding groove 231 and movable relative to the thumb turn joint 23. The resetting rotation disc 41 is provided with a slot 44 at a position corresponding to the sliding groove 231, such that a connection between the actuation structure 2 and the tail-rod resetting structure 4 may be established by the clutch pin 72 inserted into the slot 44.

In the embodiment, an electronic clutch 71 may be mounted to the cover plate 1. When an external unlocking instruction is received by the electronic clutch 71, a push bar of the electronic clutch 71 may push the clutch pin to move towards the slot 44, such that the connection between the actuation structure 2 and the tail-rod resetting structure 4 is established, and thereby the movement of a lock body may be controlled by the thumb turn 21. The external unlocking instruction may include, but not limited to, biometric verification information, card swipe information, password information, etc.

Moreover, a rebound member 73 connected to the clutch pin is arranged within the sliding groove 231. In the state where the clutch pin 72 is not pushed by the electronic clutch 71, the rebound member 73 may urge the clutch pin 72 to move out of the slot 44 and return to its original position, such that the actuation structure 2 and the tail-rod resetting structure 4 may be disengaged from each other and the actuation structure 2 may return to its initial position by the resilient restoring force of the first resetting member 5 while the tail-rod resetting structure 4 may return to its initial position by the resilient restoring force of the second resetting member 6. The rebound member 73 according to the embodiment may be implemented as a compression spring, one end of which is connected to the clutch pin 72 and the other end is connected to the thumb turn joint 23.

The push bar of the electronic clutch 71 may be pulled back to its original position within a predetermined time period, and the clutch pin 72 may be moved out of the slot 44 by a restoring force of the compression spring. At this time, it is not possible to perform the unlocking operation by means of the actuation structure 2.

Furthermore, each of the first resetting member 5 and the second resetting member 6 according to the embodiment may be implemented as a torsion spring. A leg is provided radial outwardly at either end of the torsion spring. The legs at the both ends of the torsion spring are in non-fixed connection with the cover plate 1. The cover plate 1 is provided with a stopper block 11, and the stopper block 11 is located between the legs at the both ends of the torsion spring. As the torsion spring is rotated relative to the cover plate 1, one leg of the torsion spring abuts against the stopper block 11 and cannot be rotated and thus may serve as a fixed end of the torsion spring, and the other leg may serve as a free end and may be rotated along with the actuation structure 2 or the tail-rod resetting structure 4. Specifically, the thumb turn joint 23 of the actuation structure 2 is provided with a bump 232 configured to abut against the leg of the torsion spring serving as the first resetting member 5, and the bump 232 is located between the legs at the both ends of the first resetting member 5. In this way, as the actuation structure 2 is rotated, the leg at one end of the first resetting member 5 may be blocked by the stopper block 11 and serve as the fixed end, and the other leg may serve as the free end and may be pushed by the bump 232 to cause elastic deformation of the first resetting member. Likewise, the resetting rotation disc 41 of the tail-rod resetting structure 4 is provided with a protrusion 411 configured to abut against the leg of the torsion spring serving as the second resetting member 6, and the protrusion 411 is located between the legs at the both ends of the second resetting member 6. In this way, as the resetting rotation disc 41 is rotated, the leg at one end of the second resetting member 6 may abut against the stopper block 11 and may be fixed relative to the cover plate 1, and the other leg may be pushed by the protrusion 411 to cause elastic deformation of the second resetting member 6.

It should be noted that, in the embodiment, the bolt 2001 is in an extending state when the cylinder tail rod 32 is in a state of being arranged vertically; and the bolt 2001 is in a retracted state when the cylinder tail rod 32 is in a state of being arranged transversely. In this way, the vertical state and the transverse state of the cylinder tail rod 32 may be adjusted by means of the actuation structure in conjunction with the tail-rod resetting structure 4, so as to unlock and/or lock the door lock.

In another embodiment, a resetting assembly according to the embodiment may alternatively provide a third resetting member 8. The third resetting member 8 may be preferably implemented as a torsion spring, and likewise, a leg is provided radial outwardly at either end of the torsion spring. Further, in the embodiment, the thumb turn joint 23 may extend outwardly to form a first pushing block 235, and the resetting rotation disc 41 may extend outwardly to form a second pushing block 412. Both of the first pushing block 235 and the second pushing block 412 are located between the legs at the both ends of the third resetting member 8, and the first pushing block 235 and the second pushing block 412 abut against the same leg of the third resetting member 8. Thus, in the case where the connection between the thumb turn joint 23 and the resetting rotation disc 41 is established by the connecting member, the nob connector 23 and the resetting rotation disc 41 may be in synchronously rotation, and the first pushing block 235 and the second pushing block 412 may commonly push the leg of the third resetting member 8 serving as a free end to rotate in a rotating direction of an actuation structure 2. When an external force applied to the actuation structure 2 is relieved, the first pushing block 235 and the second pushing block 412 may urge the thumb turn joint 23 and the resetting rotation disc 41, respectively, to return to original positions by the resilient restoring force of the third resetting member 8. In the case where the connection between the thumb turn joint 23 and the resetting rotation disc 41 is not established by the connecting member, when a thumb turn 21 is rotated for unlocking, the thumb turn joint 23 may be rotated and, at the same time, the first pushing block 235 on the thumb turn joint 23 may push the leg of the third resetting member 8 to cause the elastic deformation of the third resetting member 8. When an external force applied to the thumb turn 21 is relieved, the first pushing block 235 may cause the thumb turn joint 23 to return to its original position due to the restoring force of the third resetting member 8, but throughout this process the resetting rotation disc 41 may be always maintained at its original position and unlocking the door lock may be not allowed. Therefore, in the embodiment, the resetting function for the thumb turn joint 23 and the resetting rotation disc 41 may be provided using the same torsion spring, with a simple structure and convenient mounting.

In the present disclosure, the thumb turn joint 23 is further provided with an orientating screw 9 connected thereto, and the resetting rotation disc 41 is provided with a blocking piece 42 that may abut against the orientating screw 9. In this way, a direction in which the relative rotation of the thumb turn joint 23 and the resetting rotation disc 41 occurs may be restricted by means of the orientating screw 9. In other words, the thumb turn joint 23 may be rotated in the direction in which the orientating screw 9 moves far away from the blocking piece 42 relative to the resetting rotation disc 41; and in the direction in which the orientating screw 9 moves toward the blocking piece 42, it is possible to enable the synchronous rotation of the thumb turn joint 23 and the resetting rotation disc 41 by means of the orientating screw 9 pushing the blocking piece 42. Additionally, the thumb turn joint 23 is provided with a left threaded hole 233 and a right threaded hole 234, and the orientating screw 9 may be mounted depending on the unlocking direction of the door lock, such that during the unlocking through rotation, when the connection between the thumb turn joint 23 and the resetting rotation disc 41 is not established by the connecting member, the thumb turn joint 23 may be rotatable relative to the resetting rotation disc 41 and thereby the unlocking by driving the rotation of the resetting rotation disc 41 is not allowed. In the locking through the rotation in an opposite direction to the unlocking direction, the orientating screw 9 on the thumb turn joint 23 may abut against the blocking piece 42 on the resetting rotation disc 41 to push the resetting rotation disc 41 to rotate in an opposite direction, and thus the locking is allowed.

In addition, to meet users'requirements for opening a door in different directions, in order to switching a mode for unlocking and opening of a door from the left side or from the right side, it is needed to change the mounting position of the orientating screw 9 in the threaded hole on the thumb turn joint 23 and also to replace a resetting rotation disc 41 to have a rotation hole 43 facing in a different direction. In this way, it is possible to switch the direction for unlocking and opening a door. The respective structures of the rotation hole 43 in the tail-rod resetting structures corresponding to the mode for unlocking and opening of a door from the left side or from the right side, respectively, are in mirror symmetry, which ensures that the rotation of a cylinder tail rod 32 can be driven by means of the tail-rod resetting structure 4, so as to allow unlocking and locking of the door.

In summary, with a torsion spring serving as a resetting member, it is possible for the thumb-turn resetting mechanism in the present disclosure to allow individually resetting the actuation structure 2 and the tail-rod resetting structure 4. It facilitates user operation for the actuation structure 2 to control the unlocking and locking of the door lock, with simple operation and improved convenience to use.

Further, the cylinder core 31 is also provided with a lock hole 33 in communication with and coupled to the cylinder tail rod 32. If the electronic clutch 71 does not work for establishing the connection between the actuation structure 2 and the tail-rod resetting structure 4, a key may be inserted into the lock hole 33, making it possible to drive the cylinder core 31 and the cylinder tail rod 32 in synchronous rotation. In this way, it is possible to drive the cylinder core 31 and the cylinder tail rod 32 to rotate by turning the key in order to unlock the door lock.

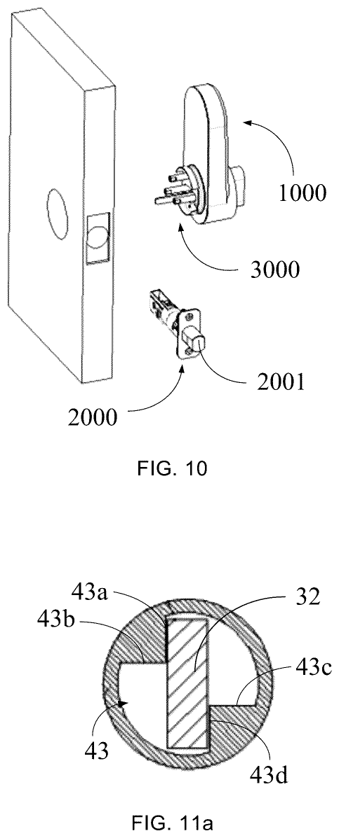

The present disclosure also relates to a smart lock with the thumb-turn resetting mechanism 3000, as shown in FIG. 10, including a lock case 1000, a lock body 2000, and a thumb turn assembly, wherein the thumb turn assembly may be the thumb-turn resetting mechanism 3000 described above. The thumb-turn resetting mechanism 3000 may be mounted in the lock case 1000. The cylinder tail rod 32 in the thumb-turn resetting mechanism 3000 may be connected to the lock body 2000, and the extending and retracting movements of the lock body 2000 relative to the lock case 1000 may be controlled using the thumb-turn resetting mechanism 3000. The smart lock according to the present disclosure may be mounted on a door via the lock case 1000.

At an end portion of the lock body 2000 is provided a bolt 2001 serving to effect direct locking for a door lock. Common types of the bolt 2001 may comprise a latch bolt, a dead bolt, etc. In the thumb-turn resetting mechanism 3000 for driving the rotation of the lock body 2000 according to the present disclosure, the rotation hole 43, through which the cylinder tail rod 32 may extend, of the resetting rotation disc 41 in the tail-rod resetting structure 4 may be varied in structures corresponding to various types of the bolt 2001, and thus it is possible to meet requirements for various types of bolts 2001.

The rotation hole 43 as described above may be shaped to conform to the outer contour of the cross section of the cylinder tail rod 32, so as to enable the bolt 2001 to be driven to return to its original position during the process of the tail-rod resetting structure 4 returning to its original position. The rotation hole 42 with such conformation design may be applicable to the automatic rebound of the latch bolt. Alternatively, the rotation hole 43 may be shaped as a profiled hole, which is similar to the structure of a bow tie and formed by two sector holes connected at their corner ends and arranged centro-symmetrically. As such, the cylinder tail rod 32 of the lock cylinder 3 may be freely rotated in the rotation hole 43 within a certain angle range. The rotation hole 43 with profiled design may be applicable to the dead bolt, for which the manual operation of a user is required to allow the extending and retracting movements of the lock body 2000.

Therefore, in another embodiment, the resetting rotation disc 41 may also be configured by a rotation disc and a rotation shaft in detachable coupling. The rotation hole 43 may be provided at the center of the rotation shaft, and the rotation shaft may be fitted and snapped into the rotation disc at its center. The rotation disc may further have the same features, such as the slot 44, the protrusion 411, and the blocking piece 42, as the resetting rotation disc 41 described above. That is, the rotation hole 43 may be separated from the resetting rotation disc 41 by providing the rotation disc and the rotation shaft in the form of a split structure, allowing replacing rotation shafts to apply rotation holes 43 of different specifications depending on requirements for various bolts. Thus, it is possible to further widen the application range of the smart lock of the present disclosure.

The locking and unlocking process for the smart lock according to the present disclosure will be specifically explained below by taking the dead bolt as an example embodiment.

During the unlocking process, at first, a correct verification code (including, but not limited to biometric verification information, door card information, password information, etc.) may be identified by the electronic clutch 71 of the thumb-turn resetting mechanism, and then the push bar of the electronic clutch 71 may be actuated to push the clutch pin 72 to insert into the slot 44 of the tail-rod resetting structure 4 such that the connection between the actuation structure 2 and the tail-rod resetting structure 4 is established. Subsequently, the thumb turn 21 of the actuation structure 2 may be turned by manual operation of a user, and the thumb turn 21 may drive the thumb turn base 22 and the thumb turn joint 23 to synchronously rotate. With the connection provided by the clutch pin 72, the thumb turn joint 23 may drive the of the resetting rotation disc 41 of the tail-rod resetting structure 4 to rotate synchronously. The resetting rotation disc 41, in turn, may drive the rotation of the cylinder tail rod 32 being coupled to the bolt 2001, such that the bolt 2001 may be driven to retract due to the rotation of the cylinder tail rod 32, so as to unlock the door lock. In the present embodiment, it is possible to unlock the door lock by the thumb turn 21 being rotated by 90 degrees.

After the unlocking is completed, the first resetting member 5 may drive the thumb turn joint 23 to return to its initial position, and the second resetting member 6 may drive the resetting rotation disc 41 to return to its initial position. The cylinder tail rod 32 may be allowed to be rotated in the rotation hole 43 relative to the resetting rotation disc 41. In the case where the angle range of the cylinder tail rod 32 being rotated in the rotation hole 43 is greater than 90 degrees, during the process of the resetting rotation disc 41 returning to its initial position by a restoring force of the second resetting member 6, the cylinder tail rod 32 may be maintained in the transverse state and the resetting rotation disc 41 may be rotated relative to the cylinder tail rod 32.

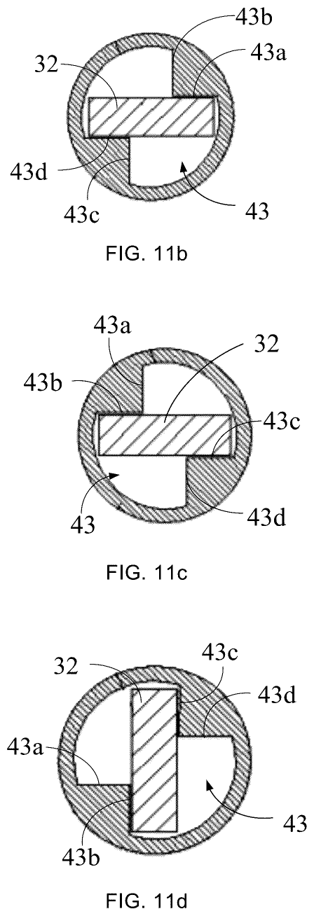

Referring to FIGS. 11a and 11b, it is required for the cylinder tail rod 32 to be rotated by 90 degrees to change from the vertical state to the transverse state, and accordingly, it is required for the thumb turn 21 of the actuation structure to be rotated by 90 degrees. In this way, the tail-rod resetting structure 4 may be driven by the thumb turn joint 23 to actuate the cylinder tail rod 32 to rotate by 90 degrees. If an external force applied thereon is relieved, the resetting rotation disc 41 may be reversely rotated by 90 degrees due to the restoring force of the second resetting member 6 and may return to its initial position, as shown in FIG. 11c.

Specifically, the rotation hole 43 of the embodiment may include a first side surface 43a, a second side surface 43b, a third side surface 43c, and a fourth side surface 43d. The first side surface 43a and the second side surface 43b are disposed adjacent to each other, and the third side surface 43c and the fourth side surface 43d are disposed adjacent to each other. In the case where both the resetting rotation disc 41 and the cylinder tail rod 32 are in an initial state, the cylinder tail rod 32 may be in the vertical state, and the first side surface 43a and the fourth side surface 43d of the rotation hole 43 may abut against the cylinder tail rod 32 and the second side surface 43b and the third side surface 43c may be not in contact with the cylinder tail rod 32. After the unlocking is completed, the cylinder tail rod 32 may be in the transverse state, and the resetting rotation disc 41 may return to its original position due to the restoring force of the second resetting member 6. At this time, the second side surface 43b and the third side surface 43c of the rotation hole 43 may abut against the cylinder tail rod 32, and the first side surface 43a and the fourth side surface 43d may be not in contact with the cylinder tail rod 32.

It should be noted that the push bar of the electronic clutch 71 will automatically return to its original position if a predetermined time period lapsed. After the push bar of the electronic clutch 71 is retracted, the clutch pin 72 may be moved out of the slot 44 of the tail-rod resetting structure 4 due to the restoring force of the compression spring, and in this case, it is not possible to control the rotation of the tail-rod resetting structure 4 through the actuation structure 2.

During the locking process, in the embodiment where the thumb turn joint 23 is coupled to the orientating screw 9 configured to restrict the rotation direction of the resetting rotation disc 41, when the thumb turn is reversely rotated to lock the door lock, the orientating screw 9 on the thumb turn joint may push the blocking piece 42 of the resetting rotation disc 41 to enable synchronous rotation of the resetting rotation disc 41 with the actuation structure 2, which in turn pushes the cylinder tail rod 32 to reversely rotate from the transverse state to the vertical state, and thereby the lock body 2000 may be protruded and thus the locking is completed, as shown in FIGS. 10c and 10d. That is, before locking is performed, the second side surface 43b and the third side surface 43c of the rotation hole 43 may abut against the cylinder tail rod 32; and as the resetting rotation disc 41 is reversely rotated by the reverse rotation of the thumb turn 21, the second side surface 43b and the third side surface 43c of the rotation hole 43 may push the cylinder tail rod 32 to reversely rotate to the vertical state, so as to the locking is completed.

In an embodiment where orientating screw 9 is not provided to restrict the rotation direction of the resetting rotation disc 41, it is possible to have the actuation structure 2 push the tail-rod resetting structure 4 to rotate using the electronic clutch 71 in conjunction with the connecting member. Therefore, before locking is performed, it may be determined whether the connection between the actuation structure 2 and the tail-rod resetting structure 4 is established by the clutch pin 72. If the connection between the actuation structure 2 and the tail-rod resetting structure 4 is not established via the connecting member, it is required to perform verification again by the user, in order to ensure that the electronic clutch 71 may be allowed to push the clutch pin 72 to establish the connection between the actuation structure 2 and the tail-rod resetting structure 4. Accordingly, if the connection between the actuation structure 2 and the tail-rod resetting structure 4 is established via the connecting member, the thumb turn 21 may be reversely rotated, meaning that the rotation direction of the thumb turn 21 during the locking process is opposite to the rotation direction thereof during the unlocking process; and the thumb turn 21 may drive the thumb turn joint 23 to reversely rotate, which in turn may drive the tail-rod resetting structure 4 to rotate with the rotation direction of the tail-rod resetting structure 4 being consistent with the rotation direction of the thumb turn joint 23. As such, the cylinder tail rod 32 may be driven to reversely rotate from the transverse state to the vertical state.

After the locking is completed, the first resetting member 5 may actuate the thumb turn joint 23 to rotate back to its initial position, and the second resetting member may actuate the resetting rotation disc 41 to rotate back to its initial position, and wherein the direction in which the thumb turn joint 23 and the resetting rotation disc 41 are rotated to return back in position is opposite to the direction in which the thumb turn 21 is rotated to perform locking. During the rotation process of the resetting rotation disc 41 to return back in position, The cylinder tail rod 32 is maintained in the vertical state, and the engagement state of the rotation hole 43 of the resetting rotation disc 41 and the cylinder tail rod 32 is resumed to the state as shown in FIG. 11a. That is, after the locking is completed, the cylinder tail rod 32 may be changed back to the vertical state, and the resetting rotation disc 41 may return to its initial position, and wherein the first side surface 43a and the fourth side surface 43d of the rotation hole 43 may abut against the cylinder tail rod 32 again until the cylinder tail rod 32 being pushed to rotate in the next unlocking operation.

In summary, with the thumb-turn resetting mechanism 3000 applied to the smart lock, it is possible in the present disclosure to ensure that the thumb turn 21 may return to its initial position upon being finished using each time, while it is not necessary for a user to manually rotate the thumb turn in order to returning it back, thereby improving the use convenience. Moreover, with the thumb-turn resetting mechanism 3000 of the present disclosure, it is possible to automatically return the thumb turn to its original position using the thumb turn and the clutch structure, with simple structure and convenient mounting. This may facilitate a reduction in the area occupied by the smart lock mounted on a door leaf, and thereby the smart lock may have high durability and reliability.

The above merely describes some embodiments of the present disclosure, and it should be noted that for a person of ordinary skill in the art, several improvements and modifications can also be made without departing from the principle of the present disclosure, and these improvements and modifications should also be considered to be within the scope of protection of the present disclosure.

What is claimed is:

1. A thumb-turn resetting mechanism, comprising:
a cover plate;
an actuation structure configured to be movable relative to the cover plate;
a lock cylinder comprising a cylinder core and a cylinder tail rod being rotatable relative to each other, wherein the cylinder core is configured to be connected to and in synchronous rotation with the actuation structure; and
a tail-rod resetting structure configured to drive the cylinder tail rod to rotate, and
wherein a connecting member is arranged between the actuation structure and the tail-rod resetting structure for establishing connection therebetween, and
wherein, a first resetting member is arranged between the cover plate and the actuation structure, a second resetting member is arranged between the tail-rod resetting structure and the cover plate, such that in the case where the connection established between the actuation structure and the tail-rod resetting structure via the connecting member is disconnected, the actuation structure and the tail-rod resetting structure are actuated to return to their original positions due to restoring force of the first resetting member and the second resetting member, respectively.

2. The thumb-turn resetting mechanism according to claim 1, wherein each of the first resetting member and the second resetting member comprises a torsion spring.

3. The thumb-turn resetting mechanism according to claim 2, wherein the actuation structure comprises a thumb turn, a thumb turn base, and a thumb turn joint all being arranged in synchronous rotation, and the thumb turn joint is provided with a bump configured to abut against the first resetting member.

4. The thumb-turn resetting mechanism according to claim 3, wherein the thumb turn joint is provided with a sliding groove, the tail-rod resetting structure is provided with a slot at a position corresponding to the sliding groove, and the connecting member comprises a clutch pin that is slidably arranged in the sliding groove.

5. The thumb-turn resetting mechanism according to claim 4, wherein a rebound member is disposed within the sliding groove and is configured to be connected to the clutch pin to allow the clutch pin being moved out of the slot and returning to its original position.

6. The thumb-turn resetting mechanism according to claim 4, wherein the cover plate is provided with an electronic clutch that is configured to receive an external control instruction to push the clutch pin to be inserted into the slot.

7. The thumb-turn resetting mechanism according to claim 3, wherein the tail-rod resetting structure includes a resetting rotation disc having a rotation hole, through which the cylinder tail rod extends, being provided at the center of the resetting rotation disc.

8. The thumb-turn resetting mechanism according to claim 7, wherein the rotation hole is shaped as a profiled hole that is formed by two sector holes being connected at their corner ends and arranged centro-symmetrically, and wherein the rotation hole has a first side surface, a second side surface, a third side surface, and a fourth side surface, and whereby the first side surface and the second side surface are provided adjacent to each other and the third side surface and the fourth side surface are provided adjacent to each other.

9. The thumb-turn resetting mechanism according to claim 7, wherein the cylinder tail rod is configured to be rotatable relative to the resetting rotation disc in the rotation hole with a rotatable range of being greater than 90 degrees.

10. The thumb-turn resetting mechanism according to claim 7, wherein the resetting rotation disc is provided with a protrusion that is configured to abut against an end of the second resetting member.

11. The thumb-turn resetting mechanism according to claim 7, wherein the thumb turn joint is provided with a left threaded hole and a right threaded hole, and the resetting rotation disc is provided with a blocking piece, and wherein an orientating screw is provided in the left threaded hole or the right threaded hole and in threaded connection thereto, and the orientating screw is configured to abut against the blocking piece, so as to restrict a direction in which a relative rotation between the tail-rod resetting structure and the actuation structure occurs.

12. The thumb-turn resetting mechanism according to claim 1, further comprising a key, and wherein the cylinder core is provided with a lock hole that is configured to accept the key being inserted therein to allow synchronous rotation of the cylinder core and the cylinder tail rod.

13. The thumb-turn resetting mechanism according to claim 1, wherein the actuation structure is configured to be pivotable or rotatable relative to the cover plate.

14. A thumb-turn resetting mechanism, comprising:
a cover plate;
a thumb turn assembly; and
a transmission assembly, wherein
the thumb turn assembly and the transmission assembly are both configured to be movable relative to the cover plate, the thumb turn assembly is connected to the transmission assembly such that the transmission assembly is controllable to control extending and retracting movements of a bolt, and wherein
the thumb turn assembly is further provided with a resetting assembly that is configured to actuate the thumb turn assembly to return to its original position after having been rotated.

15. The thumb-turn resetting mechanism according to claim 14, wherein the thumb turn assembly and the transmission assembly are both configured to be pivotable or rotatable relative to the cover plate.

16. The thumb-turn resetting mechanism according to claim 14, wherein the thumb turn assembly is configured to actuate the transmission assembly to be rotated by a rotation angle of 90 degrees in controlling the extending and retracting movements of the bolt.

17. The thumb-turn resetting mechanism according to claim 14, wherein the thumb turn assembly comprises an actuation structure and a tail-rod resetting structure, and wherein the resetting assembly comprises a third resetting member, and the actuation structure and the tail-rod resetting structure are provided with a first pushing block and a second pushing block, respectively, which are configured to be connected to the third resetting member.

18. A smart lock, comprising:
a lock case;
a thumb-turn resetting mechanism; and
a lock body, wherein
the thumb-turn resetting mechanism comprises:
a cover plate;
an actuation structure configured to be movable relative to the cover plate;
a lock cylinder comprising a cylinder core and a cylinder tail rod being rotatable relative to each other, wherein the cylinder core is configured to be connected to and in synchronous rotation with the actuation structure; and
a tail-rod resetting structure configured to drive the cylinder tail rod to rotate, and
wherein a connecting member is arranged between the actuation structure and the tail-rod resetting structure for establishing connection therebetween, and
wherein, a first resetting member is arranged between the cover plate and the actuation structure, a second resetting member is arranged between the tail-rod resetting structure and the cover plate, such that in the case where the connection established between the actuation structure and the tail-rod resetting structure via the connecting member is disconnected, the actuation structure and the tail-rod resetting structure are actuated to return to their original positions due to restoring force of the first resetting member and the second resetting member, respectively, and wherein
the thumb-turn resetting mechanism is mounted in the lock case such that the thumb-turn resetting mechanism is configured to be connected to the lock body and to control extending and retracting movements of the lock body.
